(19) United States
(12) Patent Application Publication
(10) Pub. No.: US 2025/0276538 A1
(43) Pub. Date: Sep. 4, 2025

(54) PRINTER AND METHOD

(71) Applicant: TOSHIBA TEC KABUSHIKI KAISHA, Tokyo (JP)

(72) Inventor: Satoshi Yamada, Mishima Shizuoka (JP)

(21) Appl. No.: 19/049,172

(22) Filed: Feb. 10, 2025

(30) Foreign Application Priority Data
Mar. 1, 2024 (JP) 2024-030898

(51) Int. Cl. B41J 29/48; B41J 2/32; B41J 3/407; B41J 11/00; B41J 11/48

(52) U.S. Cl. CPC B41J 29/48; B41J 2/32; B41J 3/4075; B41J 11/0095; B41J 11/48

(57) ABSTRACT

A printer in an embodiment includes a storage unit configured to store, for each of a plurality of types of roll paper, near-end information indicating whether to notify near-end of the roll paper, a paper set unit in which the roll paper can be set, a determination unit configured to determine a type of the roll paper to be used, a setting unit configured to read near-end information relating to the roll paper, the type of which was determined, from the storage unit and set the near-end information, a near-end detection unit configured to detect the near-end of the roll paper set in the paper set unit, and a near-end processing unit configured to, only if the near-end information indicating that the near-end is notified was set by the setting unit, according to detection of near-end of the roll paper by the near-end detection unit, notify the near-end.

### CROSS-REFERENCE TO RELATED APPLICATION

This application is based upon and claims the benefit of priority from Japanese Patent Application No. 2024-030898, filed on Mar. 1, 2024, the entire contents of which are incorporated herein by reference.

### FIELD

Embodiments described herein relate generally to a printer and a method.

### BACKGROUND

For example, there are a receipt printer that prints and dispenses a receipt and a label printer that prints and dispenses a label, a liner-less label, and the like. The receipt printer is installed, together with a point of sale (POS) terminal or the like, in a settlement area for settling a commodity to be sold in a store such as a supermarket, a volume retail store, or a convenience store and dispenses a receipt on which commodity information and settlement information of a commodity subjected to settlement processing by the POS terminal (a commodity purchased by a customer) are printed. The label printer is installed mainly in a back office of a store and prints information concerning a commodity (a commodity name, a commodity price, a best-before date, and the like) on label paper or liner-less label paper and dispenses a label. The dispensed label is stuck to the commodity.

Incidentally, in recent years, there is a printer functioning as both of a receipt printer and a label printer. That is, if receipt paper (roll paper) is set in the printer, the printer functions as the receipt printer that dispenses a receipt and, if a label or a liner-less label (both of which are roll paper) is set in the printer, the printer functions as the label printer.

If the printer is used as the receipt printer, operation for setting use of the receipt paper and setting a function of notifying near-end to be enabled is performed. If the printer is used as the label printer, operation for setting use of the label paper or the liner-less paper label and setting the function of notifying the near-end to be disabled is performed. In this way, paper used in the printer and enabling and disabling of near-end are separately set.

### DESCRIPTION OF THE DRAWINGS

FIG. 1 is an exterior perspective view of a printer in an embodiment;

FIG. 2 is a perspective view illustrating a configuration of an inside of the opened printer;

FIG. 3 is an explanatory diagram illustrating internal structure of the printer;

FIG. 4 is an explanatory diagram illustrating a configuration of a display window;

FIG. 5 is a block diagram illustrating hardware components of the printer;

FIG. 6 is a memory map illustrating a memory configuration of a near-end section;

FIG. 7 is a functional block diagram illustrating functional components of the printer;

FIG. 8 is a flowchart illustrating a flow of control processing for the printer;

FIG. 9 is a flowchart illustrating a flow of near-end setting processing;

FIG. 10 is a flowchart illustrating a flow of near-end selection processing;

FIG. 11 is an explanatory diagram illustrating a display example of a display unit; and

FIG. 12 is a flowchart illustrating a flow of control processing in a modification.

### DETAILED DESCRIPTION

An aspect of embodiments is to provide a printer and a method capable of omitting setting of near-end.

A printer in an embodiment includes: a storage unit configured to store, for each of a plurality of types of roll paper, near-end information indicating whether to notify near-end of the roll paper; a paper set unit in which the roll paper can be set; a determination unit configured to determine a type of the roll paper to be used; a setting unit configured to read near-end information relating to the roll paper, the type of which was determined, from the storage unit and set the near-end information; a near-end detection unit configured to detect the near-end of the roll paper set in the paper set unit; and a near-end processing unit configured to, only if the near-end information indicating that the near-end is notified was set by the setting unit, according to detection of near-end of the roll paper by the near-end detection unit, notify the near-end.

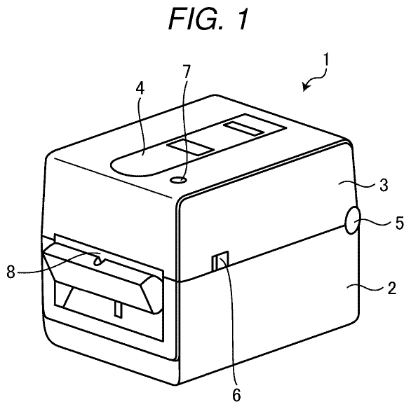

An embodiment is explained below. FIG. 1 is an exterior perspective view of a printer 1 in the embodiment. The printer 1 in the embodiment is capable of using receipt paper PA, label paper PB, and liner-less paper PC. The printer 1 according to the embodiment is used as, for example, a receipt printer that dispenses a receipt. If the printer 1 is used as the receipt printer, receipt roll paper PAa obtained by winding long paper is set in the printer 1. The surface of the receipt paper PA is formed to be printable. The printer 1 functioning as the receipt printer is installed adjacent to a POS (Point of Sales) terminal (not illustrated) functioning as an information processing device, for example, in a settlement area of a store. The printer 1 receives commodity information (information such as a commodity code, a commodity a commodity price) of a commodity subjected to settlement processing by the POS terminal and settlement information (information such as a total amount, deposit money, and change, if any, of the commodity subjected to the settlement processing) and prints the commodity information and the settlement information relating to the transaction on receipt draw-out paper PAb drawn out from the receipt roll paper PAa set on the inside of the printer 1. The printer 1 cuts the printed paper and dispense the cut paper as a receipt PAc.

The printer 1 is used as, for example, a label printer that dispenses a label. If the printer 1 is used as the label printer, label roll paper PBa obtained by winding a plurality of labels on a long liner in a long direction is set in the printer 1. The front surface of the label paper PB can be printed. The rear surface of the label paper PB has a glue surface and is peelably bonded to the liner. The printer 1 functioning as the label printer is installed, for example, in a back office of a store. The printer 1 receives printing information from an information processing device such as a PC (Personal Computer) connected to the printer 1 and prints commodity information (information such as a commodity name and a price) relating to the commodity on label draw-out paper PBb drawn out from the label roll paper PBa set on the inside of the printer 1. The printer 1 dispenses a printed label PBc from a dispensing port.

The printer 1 is used as, for example, a liner-less printer that dispenses a liner-less label. If the printer 1 is used as the liner-less printer, liner-less roll paper PCa obtained by winding a long liner-less label is set in the printer 1. The liner-less paper PC is paper used as a long seamless label. The front surface of the liner-less paper PC can be printed. A glue surface is formed on the rear surface of the liner-less paper PC. The printer 1 functioning as the liner-less printer is installed, for example, in a back office of a store. The printer 1 receives printing information from, for example, an information processing device connected to the printer 1 and prints commodity information (information such as a commodity name and a price) concerning the commodity on liner-less draw-out paper PCb drawn out from the liner-less roll paper PCa set on the inside of the printer 1. The printer 1 dispenses a printed liner-less label PCc from a dispensing port.

Note that, in the following explanation, the receipt paper PA, the label paper PB, and the liner-less paper PC are sometimes collectively referred to as paper P (for example, if not indicating specific paper). The receipt roll paper PAa, the label roll paper PBa, and the liner-less roll paper PCa are sometimes collectively referred to as roll paper Pa (for example, if not indicating specific roll paper). The receipt draw-out paper PAb, the label draw-out paper PBb, and the liner-less draw-out paper PCb are sometimes collectively referred to as draw-out paper Pb (for example, if not indicating specific paper). The receipt PAc, the label PBc, and the liner-less label PCc are sometimes collectively referred to as paper Pc (for example, if not indicating specific paper).

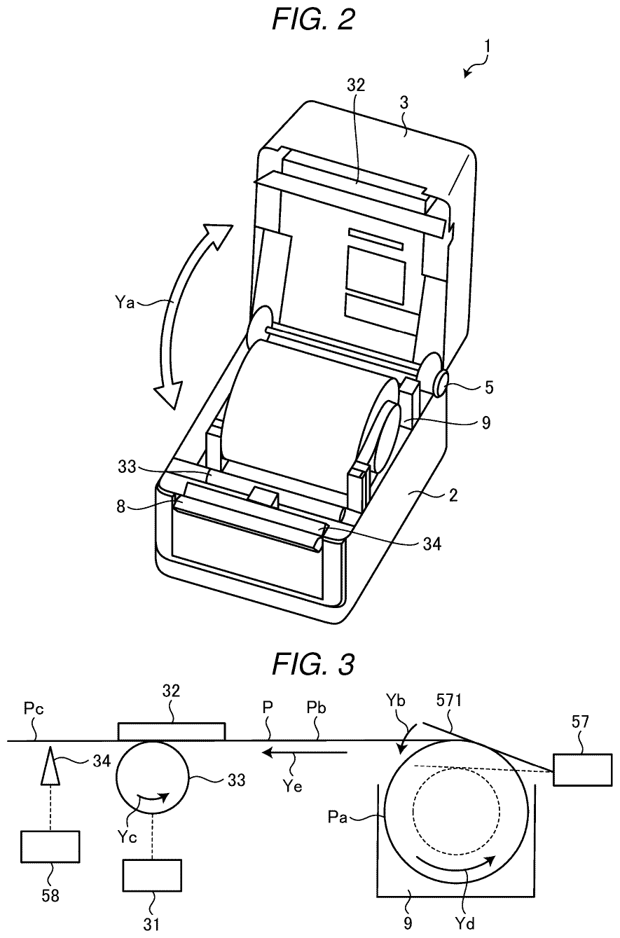

As illustrated in FIG. 1, a housing of the printer 1 is formed by a main body 2 and a lid body 3. Inside the main body 2, a power supply unit and a circuit board (both of which are not illustrated), a paper set unit 9 (see FIG. 2) for setting paper, a platen 33 (see FIG. 2) serving as a conveying unit that conveys paper, and the like are provided. The lid body 3 is connected to the main body 2 via a hinge 5. The lid body 3 is attached to be capable of turning in the up-down direction (an arrow Ya direction in FIG. 2) with respect to the main body 2 with the hinge 5 as a turning fulcrum. The lid body 3 turns upward with respect to the main body 2 to open the inside and turns downward to close the inside of the printer 1.

In the lid body 3, a printing head 32 (see FIG. 2) and a display window 4 are formed. In the main body 2 or the lid body 3, a power switch 6 for turning on and off the printer 1 is provided. A paper discharge port 8 is formed in a state in which the lid body 3 is closed on the main body 2. The paper discharge port 8 discharges (dispenses) printed paper Pc to the outside.

FIG. 2 is a perspective view illustrating a configuration of the inside of the printer 1 in the state in which the lid body 3 is opened from the main body 2. As illustrated in FIG. 2, the lid body 3 is capable of turning in a releasing direction and a closing direction indicated by an arrow Ya with respect to the main body 2.

The inside of the main body 2 includes the paper set unit 9 in which the roll paper Pa is set. A method of setting (attaching) the roll paper Pa in the paper set unit 9 may be a dropping method of dropping the roll paper Pa in the paper set unit 9 or may be an axially supporting method of inserting the axis of the roll paper Pa into a shaft (not illustrated) provided in the main body 2 and axially supporting the axis. The roll paper Pa is set in the paper set unit 9 in a state in which the lid body 3 is opened from the main body 2. In FIG. 2, a cutter 34 is provided in the main body 2. The printed paper Pc is cut by moving the cutter 34 upward.

FIG. 3 is an explanatory diagram illustrating components and positional relations of the units in the state in which the lid body 3 is closed on the main body 2. As illustrated in FIG. 3, the roll paper Pa is set in the paper set unit 9. The printing head 32 is disposed in a position facing the platen 33. The printing head 32 is in a state of being in press contact with the platen 33. If the lid body 3 is closed on the main body 2 in a state in which the draw-out paper Pb is drawn out from the roll paper Pa set in the paper set unit 9, as illustrated in FIG. 3, the paper P is held by the printing head 32 and the platen 33 are in press contact with each other. If a platen motor 31 is driven in this state, the platen 33 rotates in a direction of an arrow Yc. Then, tension occurs in the paper P held by the printing head 32 and the platen 33, the roll paper Pa set in the paper set unit 9 rotates in an arrow Yd direction, and the draw-out paper Pb drawn out from the roll paper Pa moves in an arrow Ye direction. The paper P is conveyed in this way.

The printing head 32 is, for example, a thermal head and applies heat to the conveyed paper P and performs printing. The paper P is, for example, heat sensitive paper. By applying heat to the paper P, characters and figures are printed on the surface (the surface in contact with the printing head 32) of the paper P. The paper Pc for which the printing is finished is discharged from the paper discharge port 8. At that time, the receipt paper PA and the liner-less paper PC are cut by the cutter 34 and dispensed from the paper discharge port 8 as the receipt PAc and the liner-les label PCc. The label paper PB is dispensed from the paper discharge port 8 without being cut by the cutter 34. The receipt paper PA and the liner-less paper PC are cut if a cutter motor 58 is driven to move the cutter 34 in the up-down direction.

As illustrated in FIG. 3, a near-end detection unit 57 is provided in the printer 1. The near-end detection unit 57 is attached to the lid body 3. If the lid body 3 is closed on the main body 2, a finger touch section 571 comes into contact with the outer circumferential potion of the roll paper Pa. If the draw-out paper Pb is drawn out from the roll paper Pa set in the paper set unit 9 and the diameter of the roll paper Pa decreases, the finger touch section 571 moves in a direction of an arrow Yb while keeping a state of contact with the outer circumferential portion. If the finger touch section 571 moves to a predetermined position (that is, the diameter of the roll paper Pa decreases to a predetermined length), the near-end detection unit 57 is adjusted to turn on a mechanical switch. The predetermined position is a position where the paper P is in a near-end state. The near-end refers to a state in which the length to an end (a terminal end on the innermost side) of the paper P is the predetermined length and refers to a state in which the paper P is replaced. If the mechanical switch is turned on, the near-end detection unit 57 detects the near-end of the roll paper Pa and outputs a detection signal indicating that the near-end was detected. If the lid body 3 is turned in the releasing direction from the main body 2, the near-end detection unit 57 separates from the paper P together with the finger touch section 571 according to the turning of the lid body 3. For that reason, the near-end detection unit 57 is not in the way if the roll paper Pa is set in the paper set unit 9.

In the embodiment explained above, if the printer 1 is used as the receipt printer, the near-end of the receipt paper PA (specifically, the receipt roll paper PAa) is notified and, if the printer 1 is used as the label printer, the near-end of the label paper PB (specifically, the label roll paper PBa) is not notified. If the printer 1 is used as the liner-less printer, the near-end of the liner-less paper PC (specifically, the liner-less roll paper PCa) is not notified. For that reason, the printer 1 presets and stores, according to a use form of the printer 1, near-end enabling information (near-end information) indicating that the near-end is notified and near-end disabling information indicating that the near-end is not notified. That is, in the embodiment, if the printer 1 is used as the receipt printer, the near-end enabling information indicating that the near-end is notified is set in the printer 1. Specifically, in the embodiment, if the receipt paper PA is set in the printer 1, the near-end enabling information is set in the printer 1. In the embodiment, if the printer 1 is used as the label printer or the liner-less printer, the near-end disabling information is set in the printer 1. Specifically, in the embodiment, if the label paper PB or the liner-less paper PC is set in the printer 1, the near-end disabling information is set in the printer 1.

The printer 1 in which the near-end enabling information is set notifies the near-end. The printer 1 in which the near-end disabling information is set does not notify the near-end.

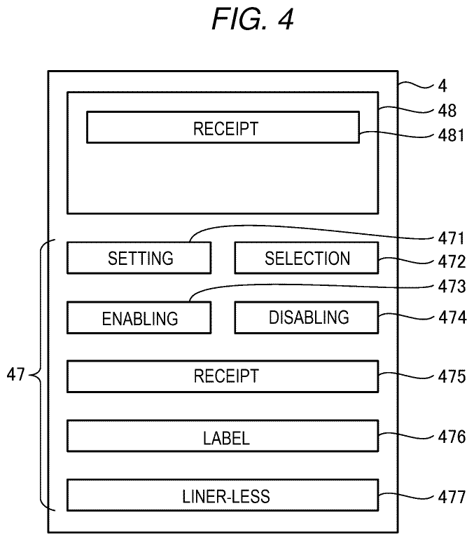

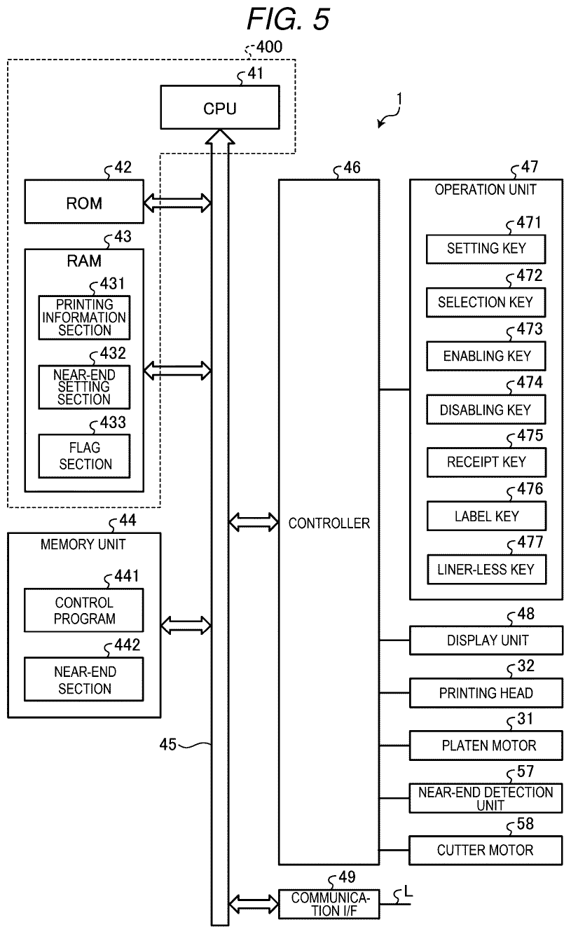

The display window 4 is explained below. The printer 1 includes the display window 4 on the upper surface of the lid body 3. FIG. 4 is an explanatory diagram illustrating a configuration of the display window 4. As illustrated in FIG. 4, the display window 4 includes a display unit 48 and an operation unit 47. The display unit 48 displays information to an operator who operates the printer 1. The display unit 48 displays a type of the paper P to be used (that is, the roll paper Pa set in the paper set unit 9). If it is determined that the paper P in use is the receipt paper PA (that is, the roll paper Pa set in the paper set unit 9 is the receipt roll paper PAa), if the near-end detection unit 57 detects near-end, the display unit 48 displays (notifies) the near-end.

The operation unit 47 includes various keys. The operation unit 47 includes a setting key 471, a selection key 472, an enabling key 473, a disabling key 474, a receipt key 475, a label key 476, and a liner-less key 477. The receipt key 475, the label key 476, and the liner-less key 477 correspond to a designation key for designating a type of the roll paper Pa.

The setting key 471 is used if near-end information (near-end enabling information or near-end disabling information) is set (stored) in a near-end section 442 (see FIG. 5) in association with each of types of usable paper P (the receipt paper PA, the label paper PB, and the liner-less paper PC). The enabling key 473 is operated if the near-end enabling information is set. The disabling key 474 is operated if the near-end disabling information is set. In the embodiment, the near-end enabling information is set in association with the receipt paper PA. The near-end disabling information is set in association with the label paper PB and the liner-less paper PC. The selection key 472 is used if the near-end information stored (set) in association with the paper P is set in the printer 1. Specifically, if the receipt key 475 is operated after the selection key 472 is operated, the near-end information (in the embodiment, the near-end enabling information) stored in association with the receipt paper PA is invoked and set in the printer 1. If the label key 476 is operated after the selection key 472 is operated, the near-end information (in the embodiment, the near-end disabling information) stored in association with the label paper PB is invoked and set in the printer 1. If the liner-less key 477 is operated after the selection key 472 is operated, the near-end information (in the embodiment, the near-end disabling information) stored in association with the liner-less paper PC is invoked and set in the printer 1.

After operating the selection key 472, the operator of the printer 1 operates a key (any one of the receipt key 475, the label key 476, and the liner-less key 477) corresponding to a type of the roll paper Pa set in the paper set unit 9 to designate a type of the paper P. The display unit 48 displays characters 481 indicating the designated paper P according to a type of the key operated after the selection key 472 is operated. Specifically, if the receipt key 475 is operated after the selection key 472 is operated, the characters 481 of “receipt” are displayed assuming that the receipt paper PA was designated. If the label key 476 is operated after the selection key 472 is operated, the characters 481 of “label” are displayed assuming that the label paper PB was designated. If the liner-less key 477 is operated after the selection key 472 is operated, the characters 481 of “liner-less” is displayed assuming that the liner-less paper PC was designated. In the example illustrated in FIG. 4, “receipt” is displayed.

Hardware of the printer 1 is explained below. FIG. 5 is a block diagram illustrating hardware components of the printer 1. As illustrated in FIG. 5, the printer 1 includes a CPU (Central Processing Unit) 41 that is an example of a processor, a ROM (Read Only Memory) 42, a RAM (Random Access Memory) 43, and a memory unit 44. The CPU 41 is a control entity. The ROM 42 stores various programs. Programs and various data are loaded in the RAM 43. The memory unit 44 stores various programs. The CPU 41, the ROM 42, the RAM 43, and the memory unit 44 are connected to one another via a bus 45. The CPU 41, the ROM 42, and the RAM 43 configure a control unit 400. That is, the CPU 41 operates according to a control program stored in the ROM 42 or the memory unit 44 and loaded in the RAM 43, whereby the control unit 400 executes control processing for the printer 1 explained below.

The RAM 43 includes a printing information section 431, a near-end setting section 432, and a flag section 433. The printing information section 431 stores printing information received from an information processing device. The near-end setting section 432 stores near-end information read from a near-end section 422 explained below. The flag section 433 stores flag information corresponding to a type of selected paper P.

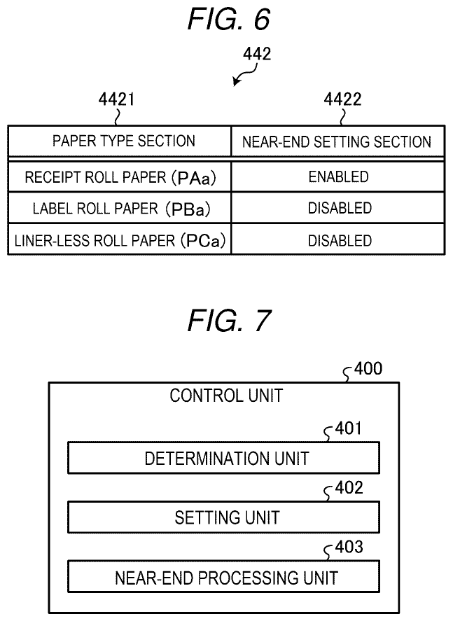

The memory unit 44 is configured by a nonvolatile memory such as an HDD (Hard Disc Drive) or a flash memory in which stored information is retained even if the power is turned off. The memory unit 44 includes a control program section 441 and a near-end section 422 (a storage unit). The control program section 441 stores a control program for controlling the printer 1. The near-end section 442 stores near-end information in association with the roll paper Pa to be used (the roll paper Pa set in the paper set unit 9). The near-end section 442 is explained below with reference to FIG. 6.

The control unit 400 is connected to the operation unit 47, the display unit 48, the printing head 32, the platen motor 31, the near-end detection unit 57, and the cutter motor 58 via the bus 45 and a controller 46. The operation unit 47 is a key for operating the printer 1 and includes the setting key 471, the selection key 472, the enabling key 473, the disabling key 474, the receipt key 475, the label key 476, and the liner-less key 477. The display unit 48 displays information to the operator who operates the printer 1.

The printing head 32 applies heat to the surface of the paper P to print characters and figures on the surface of the paper P. The platen motor 31 drives to rotate the platen 33. The near-end detection unit 57 detects near-end of the roll paper Pa. If receiving a detection signal from the near-end detection unit 57, the control unit 400 determines that the roll paper Pa set in the paper set unit 9 is near end. The cutter motor 58 drives to move the cutter 34 up and down.

The controller 46 receives an instruction from the control unit 400 and controls the operation unit 47 and the display unit 48. In the following explanation, for convenience of explanation, it is assumed that the control unit 400 performs control performed by the controller 46.

The control unit 400 is connected to a communication unit 49 via the bus 45. The communication unit 49 is communicably connected to, via a communication line L such as a LAN (Local Area Network), an information processing device that transmits printing information.

Subsequently, the near-end section 442 is explained. FIG. 6 is a memory map illustrating a memory configuration of the near-end section 442. The near-end section 442 stores near-end information set for each of types of the paper P (specifically, the roll paper Pa) in association with a plurality of types of the paper P (specifically, the roll paper Pa) usable in the printer 1. As illustrated in FIG. 6, the near-end section 442 includes a paper type section 4421 and a near-end setting section 4422. The paper type section 4421 stores information concerning the paper P (specifically, the roll paper Pa) that can be used in the printer 1 (can be set in the paper set unit 9). In the embodiment, as the information concerning the paper P that can be used in the printer 1 (can be set in the paper set unit 9), the paper type section 4421 stores information for specifying the receipt paper PA (specifically, the receipt roll paper PAa), information for specifying the label paper PB (specifically, the label roll paper PBa), and information for specifying the liner-less paper PC (specifically, the liner-less roll paper PCa). The near-end setting section 4422 stores near-end information in association with the paper P (specifically, the roll paper Pa) stored in the near-end section 442. In the embodiment, the near-end setting section 4422 stores, in association with the receipt paper PA (specifically, the receipt roll paper PAa), near-end enabling information indicating that near-end is notified. The near-end setting section 4422 stores, in association with the label paper PB (specifically, the label roll paper PBa), near-end disabling information indicating that near-end is not notified. The near-end setting section 4422 stores, in association with the liner-less paper PC (specifically, the liner-less roll paper PCa), near-end disabling information indicating that near-end is not notified.

Functional components of the printer 1 are explained below. FIG. 7 is a functional block diagram illustrating the functional components of the printer 1. The control unit 400 of the printer 1 follows a control program stored in the ROM 42 or the control program section 441 of the memory unit 44 to function as a determination unit 401, a setting unit 402, and a near-end processing unit 403.

The determination unit 401 determines a type of the roll paper Pa to be used. Specifically, the determination unit 401 determines, based on input information indicating a type of the roll paper Pa, a type of the roll paper Pa to be used. In the embodiment, if any one key among the receipt key 475, the label key 476, and the liner-less key 477 is operated, since a key signal indicating the operated key is input, the determination unit 401 determines a type of the operated key (that is, a type of the roll paper Pa to be used) based on the input key signal.

The setting unit 402 reads near-end information relating to the roll paper Pa, the type of which was determined, from the near-end section 442 and sets the near-end information. Specifically, the setting unit 402 reads the near-end information relating to the roll paper Pa, the type of which was determined, from the near-end section 442 and stores the near-end information in the near-end setting section 432. In the embodiment, the setting unit 402 determines, based on the input key signal, which key among the receipt key 475, the label key 476, and the liner-less key 477 was operated, determines the roll paper Pa to be used, reads near-end information corresponding to the determined roll paper Pa, and stores the near-end information in the near-end setting section 432.

Only if the near-end enabling information indicating that near-end is notified was set by the setting unit 402, according to detection of near-end of the roll paper Pa by the near-end detection unit 57, the near-end processing unit 403 notifies the near-end. In the embodiment, the near-end enabling information is set for the receipt paper PA and the near-end disabling information is set (that is, the near-end enabling information is not set) for the label paper PB and the liner-less paper PC. Therefore, if near-end of the receipt roll paper PAa is detected by the near-end detection unit 57, the near-end processing unit 403 notifies the near-end. If near-end of the label roll paper PBa is detected by the near-end detection unit 57 and if near-end of the liner-less roll paper PCa is detected by the near-end detection unit 57, the near-end processing unit 403 does not notify the near-end.

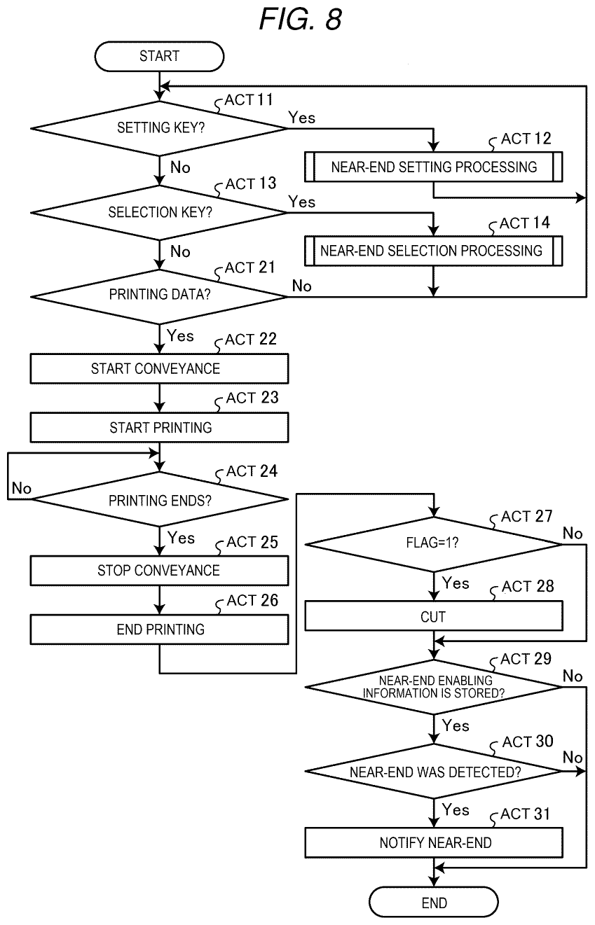

Control of the printer 1 is explained below. FIG. 8 is a flowchart illustrating a flow of control processing for the printer 1. As illustrated in FIG. 8, the control unit 400 of the printer 1 determines whether the setting key 471 was operated (Act 11). If determining that the setting key 471 was operated (Yes in Act 11), the control unit 400 executes near-end setting processing (Act 12).

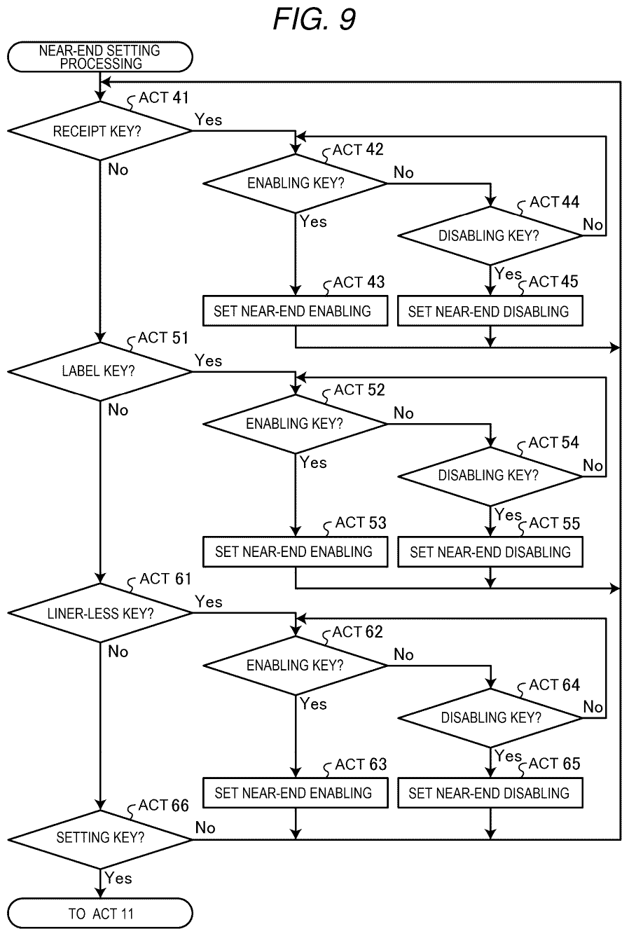

FIG. 9 is a flowchart illustrating the near-end setting processing executed in Act 12. As illustrated in FIG. 9, the control unit 400 determines whether the receipt key 475 was operated (Act 41). If determining that the receipt key 475 was operated (Yes in Act 41), subsequently, the control unit 400 determines whether the enabling key 473 was operated (Act 42). If determining that the enabling key 473 was operated (Yes in Act 42), the control unit 400 sets (stores), in the near-end setting section 4422 corresponding to information indicating the receipt roll paper PAa stored in the paper type section 4421, “near-end enabling information” that is near-end information indicating that, if the near-end detection unit 57 detected near-end, the near-end is notified (Act 43). Then, the control unit 400 returns to Act 41.

If determining that the enabling key 473 was not operated (No in Act 42), the control unit 400 determines whether the disabling key 474 was operated (Act 44). If determining that the disabling key 474 was operated (Yes in Act 44), the control unit 400 sets (stores), in the near-end setting section 4422 corresponding to the information indicating the receipt roll paper PAa stored in the paper type section 4421, “near-end disabling information” that is near-end information indicating that it is not determined whether near-end was detected by the near-end detection unit 57 (Act 45). Then, the control unit 400 returns to Act 41. In the embodiment, since near-end is notified if the receipt roll paper PAa is set, the “near-end enabling information” is set in the near-end setting section 4422 corresponding to the information indicating the receipt roll paper PAa. If determining that the disabling key 474 was not operated (No in Act 44), the control unit 400 returns to Act 42.

If determining that the receipt key 475 was not operated (No in Act 41), the control unit 400 determines whether the label key 476 was operated (Act 51). If determining that the label key 476 was operated (Yes in Act 51), subsequently, the control unit 400 determines whether the enabling key 473 was operated (Act 52). If determining that the enabling key 473 was operated (Yes in Act 52), the control unit 400 sets (stores), in the near-end setting section 4422 corresponding to information indicating the label roll paper PBa stored in the paper type section 4421, “near-end enabling information” that is near-end information indicating that, if the near-end detection unit 57 detected near-end, the near-end is notified (Act 53). Then, the control unit 400 returns to Act 41.

If determining that the enabling key 473 was not operated (No in Act 52), the control unit 400 determines whether the disabling key 474 was operated (Act 54). If determining that the disabling key 474 was operated (Yes in Act 54), the control unit 400 sets (stores), in the near-end setting section 4422 corresponding to information indicating the label roll paper PBa stored in the paper type section 4421, “near-end disabling information” that is near-end information indicating that it is not determined whether near-end was detected by the near-end detection unit 57 (Act 55). Then, the control unit 400 returns to Act 41. In the embodiment, since near-end is not notified if the label roll paper PBa is set, the “near-end disabling information” is set in the near-end setting section 4422 corresponding to the information indicating the label roll paper PBa. If determining that the disabling key 474 was not operated (No in Act 54), the control unit 400 returns to Act 52.

If determining that the label key 476 was not operated (No in Act 51), the control unit 400 determines whether the liner-less key 477 was operated (Act 61). If determining that the liner-less key 477 was operated (Yes in Act 61), subsequently, the control unit 400 determines whether the enabling key 473 was operated (Act 62). If determining that the enabling key 473 was operated (Yes in Act 62), the control unit 400 sets (stores), in the near-end setting section 4422 corresponding to information indicating the liner-less roll paper PCa stored in the paper type section 4421, “near-end enabling information” that is near-end information indicating that, if the near-end detection unit 57 detected near-end, the near-end is notified (Act 63). Then, the control unit 400 returns to Act 41.

If determining that the enabling key 473 was not operated (No in Act 62), the control unit 400 determines whether the disabling key 474 was operated (Act 64). If determining that the disabling key 474 was operated (Yes in Act 64), the control unit 400 sets (stores), in the near-end setting section 4422 corresponding to the information indicating the liner-less roll paper PCa stored in the paper type section 4421, “near-end disabling information” that is near-end information indicating that it is not determined whether near-end was detected by the near-end detection unit 57 (Act 65). Then, the control unit 400 returns to Act 41. In the embodiment, since near-end is not notified if the liner-less roll paper PCa is set, the “near-end disabling information” is set in the near-end setting section 4422 corresponding to the information indicating the liner-less roll paper PCa. If determining that the disabling key 474 was not operated (No in Act 64), the control unit 400 returns to Act 62.

If determining that the liner-less key 477 was not operated (No in Act 61), the control unit 400 determines whether the setting key 471 was operated again (Act 66). If determining that the setting key 471 was operated (Yes in Act 66), the control unit 400 returns to Act 11. If determining that the setting key 471 was not operated (No in Act 66), the control unit 400 returns to Act 41.

Referring back to FIG. 8, if determining that the setting key 471 was not operated (No in Act 11), the control unit 400 determines whether the selection key 472 was operated (Act 13). If determining that the selection key 472 was operated (Yes in Act 13), the control unit 400 executes near-end selection processing (Act 14).

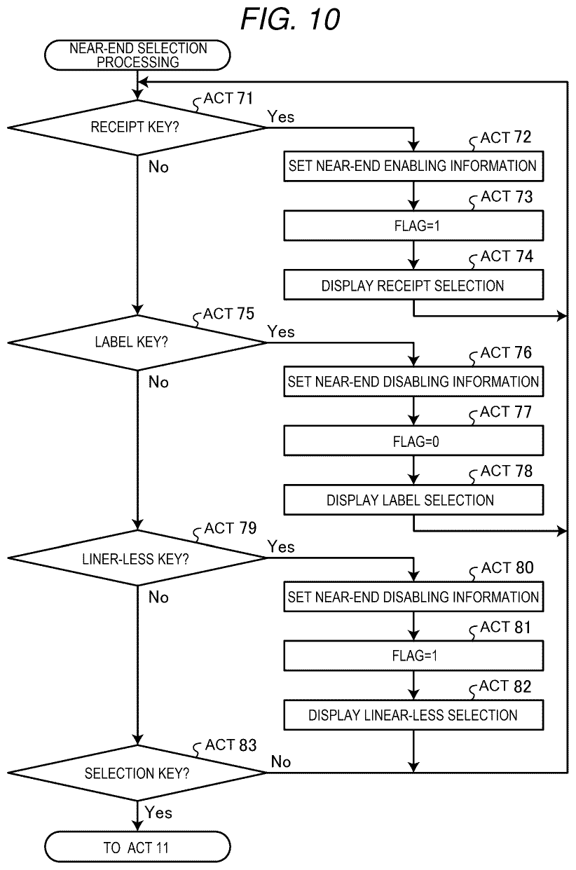

FIG. 10 is a flowchart illustrating the near-end selection processing executed in Act 14. If the operator of the printer 1 set the receipt roll paper PAa in the paper set unit 9, the operator of the printer 1 operates the receipt key 475 subsequently to the operation of the selection key 472. If the operator set the label roll paper PBa in the paper set unit 9, the operator operates the label key 476 subsequently to the operation of the selection key 472. If the operator set the liner-less roll paper PCa in the paper set unit 9, the operator operates the liner-less key 477 subsequently to the operation of the selection key 472.

As illustrated in FIG. 10, the determination unit 401 determines whether the receipt key 475 was operated (Act 71). If it is determined that the receipt key 475 was operated (Yes in Act 71), the setting unit 402 reads near-end information (in the embodiment, “near-end enabling information”) stored in the near-end setting section 4422 corresponding to the receipt roll paper PAa stored in the paper type section 4421 and stores the near-end information in the near-end setting section 432 (Act 72). The control unit 400 stores, in the flag section 433, flag information “1” indicating that the control unit 400 causes the cutter 34 to operate (Act 73). The control unit 400 displays, on the display unit 48, the characters 481 (in the embodiment, “receipt”) indicating that the receipt roll paper PAa was set in the paper set unit 9 (Act 74). Then, the control unit 400 returns to Act 71.

If determining that the receipt key 475 was not operated (No in Act 71), the determination unit 401 determines whether the label key 476 was operated (Act 75). If it is determined that the label key 476 was operated (Yes in Act 75), the setting unit 402 reads near-end information (in the embodiment, “near-end disabling information”) stored in the near-end setting section 4422 corresponding to the label roll paper PBa stored in the paper type section 4421 and stores the near-end information in the near-end setting section 432 (Act 76). The control unit 400 stores, in the flag section 433, flag information “0” indicating that the control unit 400 does not cause the cutter 34 to operate (Act 77). The control unit 400 displays, on the display unit 48, the characters 481 (in the embodiment, “label”) indicating that the label roll paper PBa was set in the paper set unit 9 (Act 78). Then, the control unit 400 returns to Act 71.

If determining that the label key 476 was not operated (No in Act 75), the determination unit 401 determines whether the liner-less key 477 was operated (Act 79). If it is determined that the liner-less key 477 was operated (Yes in Act 79), the setting unit 402 reads near-end information (in the embodiment, “near-end disabling information”) stored in the near-ed setting section 4422 corresponding to the liner-less roll paper PCa stored in the paper type section 4421 and stores the near-end information in the near-end setting section 432 (Act 80). The control unit 400 stores, in the flag section 433, flag information “1” indicating that the control unit 400 causes the cutter 34 to operate (Act 81). The control unit 400 displays, on the display unit 48, the characters 481 (in the embodiment, “liner-less”) indicating that the liner-less roll paper PCa was set in the paper set unit 9 (Act 82). Then, the control unit 400 returns to Act 71.

If determining that the liner-less key 477 was not operated (No in Act 79), the control unit 400 determines whether the selection key 472 was operated again (Act 83). If determining that the selection key 472 was operated (Yes in Act 83), the control unit 400 returns to Act 11. If determining that the selection key 472 was not operated (No in Act 83), the control unit 400 returns to Act 71.

Referring back to FIG. 8, if determining that the selection key 472 was not operated (No in Act 13), the control unit 400 determines whether printing data was received from the information processing device (Act 21). If determining that printing data was not received (No in Act 21), the control unit 400 returns to Act 11. If determining that printing data was received (Yes in Act 21), the control unit 400 drives the platen motor 31 to rotate the platen 33 and starts conveyance of the paper P (Act 22). Then, the control unit 400 drives the printing head 32 to start printing of information on the surface of the paper P (Act 23).

Subsequently, the control unit 400 determines whether the printing of the received printing information ended (all the received printing information was printed) (Act 24). The control unit 400 continues the conveyance of the paper P and the printing until the printing ends (No in Act 24). If determining that the printing of the printing information ended (Yes in Act 24), the control unit 400 stops the rotation of the platen 33 and stops the conveyance of the paper P (Act 25). Then, the control unit 400 ends the printing by the printing head 32 (Act 26). The paper Pc printed in this way is discharged from the paper discharge port 8.

Subsequently, the control unit 400 checks flag information stored in the flag section 433 and determines whether flag information “1” is stored in the flag section 433 (Act 27). If determining that the flag information “1” is stored (Yes in Act 27), the control unit 400 drives the cutter 34 to cut the paper Pc discharged (dispensed) from the paper discharge port 8 (Act 28). If the flag information “1” is not stored in the flag section 433 (that is, flag information “0” is stored) (No in Act 27), the control unit 400 does not drive the cutter 34. That is, the control unit 400 does not execute processing in Act 28.

Subsequently, the control unit 400 determines whether near-end enabling information is stored in the near-end setting section 432 (Act 29). If determining that the near-end enabling information is stored (Yes in Act 29), subsequently, the control unit 400 determines whether the near-end detection unit 57 detected near-end of the roll paper Pa (Act 30). If it is determined that near-end was detected (Yes in Act 30), the near-end processing unit 403 displays (notifies), on the display unit 48, near-end detection information indicating that the paper P is near end (Act 31).

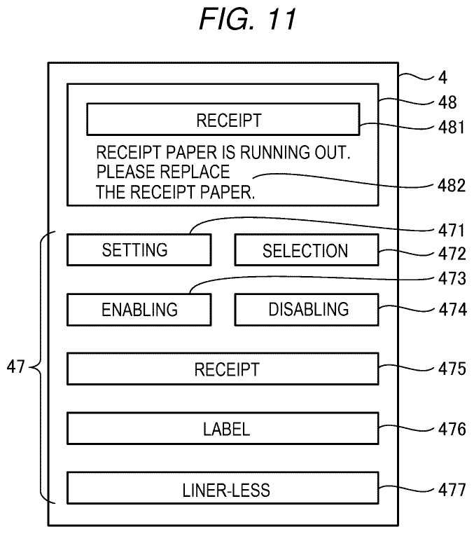

FIG. 11 illustrates the display unit 48 that displays, in Act 31, near-end detection information 482 indicating that the receipt paper PA (the receipt roll paper PAa) is near end. As illustrated in FIG. 11, the display unit 48 displays the near-end detection information 482 indicating that the receipt roll paper PAa is near end. In an example illustrated in FIG. 11, as the near-end detection information 482, for example, “Receipt paper is running out. Please replace the receipt paper.” is displayed. The control unit 400 ends the processing and returns to Act 11.

Referring back to FIG. 8, if determining that the near-end enabling information is not stored in the near-end setting section 432 (that is, near-end disabling information is stored) (No in Act 29), the control unit 400 ends the processing without determining (the determination in Act 30) whether the near-end detection unit 57 detected near-end and returns to Act 11. That is, if determining No in Act 29, since the control unit 400 does not perform the determination in Act 30, the control unit 400 does not perform the processing in Act 31 (processing for displaying (notifying) the near-end detection information on the display unit 48). If determining that near-end was not detected (No in Act 30), the control unit 400 ends the processing and returns to Act 11.

According to the embodiment explained above, if a type of the roll paper Pa was designated by the designation key, near-end information stored in the near-end section 442 and corresponding to the designated roll paper Pa is stored in the near-end setting section 432, on condition that near-end enabling information indicating that near-end is notified is stored in the near-end setting section 432, it is determined whether the near-end detection unit 57 detected near-end, and, if it is determined that the near-end detection unit 57 detected near-end, near-end detection information indicating that the roll paper Pa is near end is displayed on the display unit 48. Conversely, if near-end disabling information indicating that near-end is not notified is stored in the near-end setting section 432, it is not determined whether the near-end detection unit 57 detected near-end and near-end detection information indicating that the roll paper Pa is near end is not displayed on the display unit 48.

A modification of the printer 1 is explained below. In the embodiment, if near-end enabling information indicating that near-end is notified is stored in the near-end setting section 432, it is determined whether the near-end detection unit 57 detected near-end of the paper P (the determination in Act 30 is performed in the case of Yes in the determination in Act 29). If near-end disabling information indicating that near-end is not detected is stored in the near-end setting section 432, it is not determined whether the near-end detection unit 57 detected near-end of the paper P (the determination in Act 30 is not executed in the case of No in the determination in Act 29).

In the modification of the embodiment, first, it is determined whether the near-end detection unit 57 detected near-end of the paper P. If it is determined that the near-end detection unit 57 detected near-end, subsequently, it is determined whether near-end enabling information indicating that near-end is notified is stored in the near-end setting section 432. In the explanation of the modification, the same components as the components in the embodiment are denoted by the same reference numerals and signs and explanation of the components is omitted or simplified.

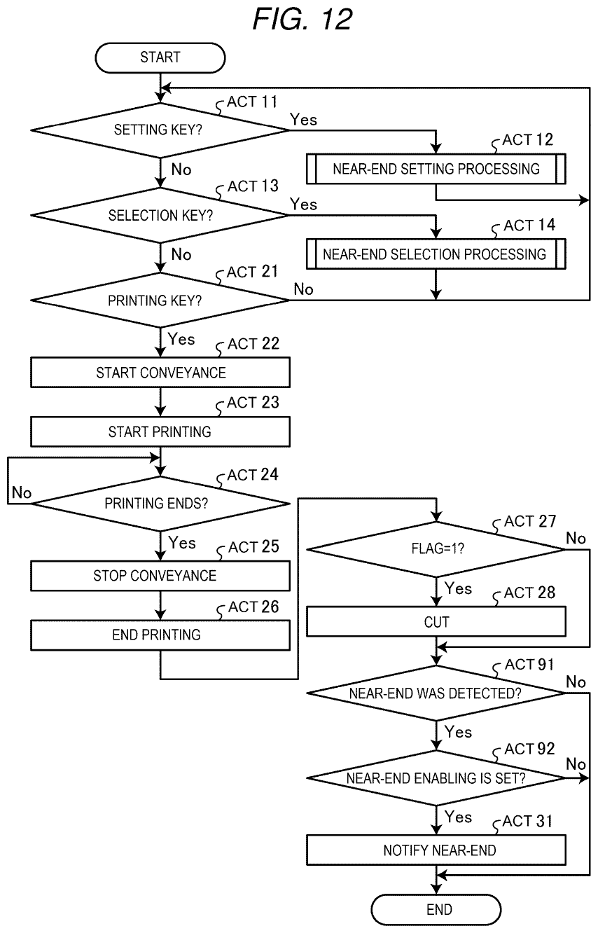

FIG. 12 is a flowchart illustrating a flow of control processing in the modification. FIG. 12 is a diagram corresponding to FIG. 8 in the embodiment. As illustrated in FIG. 12, the same processing as the processing in the embodiment is performed in Act 11 to Act 28 and Act 31. In the modification, the processing in Act 45, Act 55, and Act 65 in FIG. 9 in the near-end setting processing (Act 12) is performed as explained below.

In the case of the modification, in the case of Yes in the determination in Act 44, the control unit 400 sets (stores), in the near-end setting section 4422 corresponding to the information indicating the receipt roll paper PAa stored in the paper type section 4421, “near-end disabling information” that is near-end information indicating that, even if near-end was detected by the near-end detection unit 57, the near-end is not notified (Act 45). In the case of Yes in the determination in Act 54, the control unit 400 sets (stores), in the near-end setting section 4422 corresponding to the information indicating the label roll paper PBa stored in the paper type section 4421, “near-end disabling information” that is near-end information indicating that, even if near-end was detected by the near-end detection unit 57, the near-end is not notified (Act 55). In the case of Yes in the determination in Act 64, the control unit 400 sets (stores), in the near-end setting section 4422 corresponding to the information indicating the liner-less roll paper PCa stored in the paper type section 4421, “near-end disabling information” that is near-end information indicating that, even if near-end was detected by the near-end detection unit 57, the near-end is not notified (Act 65).

After executing the processing in Act 28, the control unit 400 determines whether the near-end detection unit 57 detected near-end of the roll paper Pa (Act 91). If determining that the near-end detection unit 57 detected near-end (Yes in Act 91), subsequently, the control unit 400 determines whether near-end enabling information is stored in the near-end setting section 432 (Act 92). If it is determined that the near-end enabling information is stored (Yes in Act 92), the near-end processing unit 403 displays (notifies), on the display unit 48, near-end detection information indicating that the paper P is near end (Act 31). If it is determined that near-end enabling information is not stored (near-end disabling information is stored) (No in Act 92), the near-end processing unit 403 does not display the near-end detection information on the display unit 48. That is, if it is determined that near-end enabling information is not stored (No in Act 92), the near-end processing unit 403 does not execute the processing in Act 31. That is, even if the near-end detection unit 57 detects near-end of the roll paper Pa, if near-end disabling information is stored in the near-end setting section 432, the near-end processing unit 403 does not display the near-end detection information on the display unit 48.

According to the modification explained above, if a type of the roll paper Pa is designated by a designation key, near-end information corresponding to the selected roll paper Pa stored in the near-end section 442 is stored in the near-end setting section 432, on condition that the near-end detection unit 57 detected near-end, it is determined whether near-end enabling information is stored in the near-end setting section 432, and, if it is determined that near-end enabling information is stored, near-end detection information indicating that the roll paper Pa is near end is displayed on the display unit 48. Conversely, if near-end disabling information is stored in the near-end setting section 432, even if the near-end detection unit 57 detects near-end, the near-end detection information indicating that the roll paper Pa is near end is not displayed on the display unit 48.

As explained above, the printer 1 in the embodiment and the modification includes the near-end section 442 that stores, for each of a plurality of types of roll paper Pa, near-end information indicating whether near-end of the roll paper Pa is notified, the paper set unit 9 in which the roll paper Pa can be set, the determination unit 401 that determines a type of the roll paper Pa to be used, the setting unit 402 that reads near-end information relating to the roll paper Pa, the type of which was determined, from the near-end section 442 and sets the near-end information, the near-end detection unit 57 that detects near-end of the roll paper Pa set in the paper set unit 9, and the near-end processing unit 403 that, only if near-end information indicating that near-end is notified was set by the setting unit 402, according to detection of near-end of the roll paper Pa by the near-end detection unit 57, notifies the near-end.

With the printer 1 in the embodiment and the modification explained above, if a type of the roll paper Pa to be used is determined, near-end information relating to the roll paper Pa is read from the near-end section 442 and stored in the near-end setting section 432, and, if near-end enabling information is set in the near-end setting section 432, according to detection of near-end of the roll paper Pa by the near-end detection unit 57, the near-end is notified. For that reason, it is possible to omit setting of near-end performed every time separately from setting of the roll paper Pa in the related art.

The embodiment is explained above. However, the embodiment is presented as an example and is not intended to limit the scope of the invention. The new embodiment can be implemented in other various forms. Various omissions, substitutions, changes, and combinations can be made without departing from the gist of the invention. The embodiment and modifications of the embodiment are included in the scope and the gist of the invention and included in the inventions described in claims and the scope of equivalents of the inventions.

For example, in the embodiment and the modification, the near-end detection unit 57 is explained as the mechanical switch. However, not only this, but, for example, the near-end detection unit 57 may be a transmissive or reflective optical sensor.

In the embodiment and the modification, the near-end enabling information is stored in association with the receipt paper PA and the near-end disabling information is stored in association with the label paper PB and the liner-less paper PC. However, not only this, but the near-end enabling information only has to be stored in association with the paper P for which near-end needs to be notified.

In the embodiment and the modification, the receipt paper PA and the liner-less paper PC are cut by the cutter 34. However, the cut of the paper P is not an essential requirement.

Programs to be executed in the printer 1 in the embodiment and the modification are provided by being recorded in a computer-readable recording medium such as a CD-ROM, a flexible disk (FD), a CD-R, or a DVD (Digital Versatile Disk) as a file of an installable format or an executable format.

The programs to be executed in the printer in the embodiment and the modification may be configured to be stored on a computer connected to a network such as the Internet and provided by being downloaded through the network. The programs to be executed in the printer 1 in the embodiment and the modification may be configured to be provided or distributed through the network such as the Internet.

The programs to be executed in the printer 1 in the embodiment and the modification may be configured to be provided by being incorporated in a ROM or the like in advance.

What is claimed is:

1. A printer, comprising:
a storage component configured to store, for each of a plurality of types of roll paper, near-end information indicating whether to notify near-end of the roll paper;
a paper set component in which the roll paper is set;
a determination component configured to determine a type of the roll paper to be used;
a setting component configured to read near-end information relating to the roll paper, the type of which is determined, from the storage component and set the near-end information;
a near-end detection component configured to detect the near-end of the roll paper set in the paper set component; and
a near-end processing component configured to, only if the near-end information indicating that the near-end is notified is set by the setting component, according to detection of near-end of the roll paper by the near-end detection component, notify the near-end.

2. The printer according to claim 1, wherein
the plurality of types of roll paper comprise receipt roll paper obtained by winding long receipt paper, label roll paper obtained by aligning and winding a plurality of labels in a long direction on a long liner, and liner-less roll paper obtained by winding long liner-less paper,
the storage component stores, in association with the receipt roll paper, near-end information for notifying near-end and stores, in association with the label roll paper and the liner-less roll paper, near-end information for not notifying near-end, and
the setting component sets near-end information indicating that the near-end is notified if the receipt roll paper is determined by the determination component.

3. The printer according to claim 1, wherein, if near-end information indicating that the near-end is not notified is set by the setting component, the near-end processing component does not determine whether near-end of the roll paper is detected by the near-end detection component and does not notify the near-end.

4. The printer according to claim 1, wherein, if near-end information indicating that the near-end is not notified is set by the setting component, even if near-end of the roll paper is detected by the near-end detection component, the near-end processing unit does not notify the near-end.

5. The printer according to claim 1, further comprising a designation key that is operated in order to designate a type of roll paper, wherein
the determination component determines the roll paper for which the designation key operates.

6. The printer according to claim 1, wherein the near-end information comprises near-end disabling information and near-end enabling information.

7. The printer according to claim 1, wherein the determination component determines that when a receipt key is operated, the setting component reads near-end information stored in a near-end setting component corresponding to the roll paper stored in the paper set component and stores the near-end information in the near-end setting component.

8. A method for a printer including a storage component configured to store, for each of a plurality of types of roll paper, near-end information indicating whether to notify near-end of the roll paper, a paper set component in which the roll paper can be set, and a near-end detection unit configured to detect the near-end of the roll paper set in the paper set component,
the method comprising:
determining a type of the roll paper to be used;
reading near-end information relating to the roll paper, the type of which is determined, from the storage component and setting the near-end information; and
only if the near-end information indicating that the near-end is notified is set, according to detection of near-end of the roll paper, notifying the near-end.

9. The method to claim 8, wherein the plurality of types of roll paper comprise receipt roll paper obtained by winding long receipt paper, label roll paper obtained by aligning and winding a plurality of labels in a long direction on a long liner, and liner-less roll paper obtained by winding long liner-less paper, the method further comprising:
storing, in association with the receipt roll paper, near-end information for notifying near-end and storing, in association with the label roll paper and the liner-less roll paper, near-end information for not notifying near-end, and
setting near-end information indicating that the near-end is notified if the receipt roll paper is determined.

10. The method according to claim 8, further comprising:
if near-end information indicating that the near-end is not notified is set, not determining whether near-end of the roll paper is detected by the near-end detection component and not notifying the near-end.

11. The method according to claim 8, further comprising:
if near-end information indicating that the near-end is not notified is set, even if near-end of the roll paper is detected, not notifying the near-end.

12. The method according to claim 8, further comprising:
operating a designation key in order to designate a type of roll paper; and
determining the roll paper for which the designation key operates.

13. The method according to claim 8, further comprising:
determining that when a receipt key is operated, the reading near-end information stored in a near-end setting component corresponding to the roll paper stored in the paper set component and storing the near-end information in the near-end setting component.

14. A thermal printer, comprising:
a thermal print head;
a storage component configured to store, for each of a plurality of types of roll paper, near-end information indicating whether to notify near-end of the roll paper;
a paper set component in which the roll paper is set;
a determination component configured to determine a type of the roll paper to be used;
a setting component configured to read near-end information relating to the roll paper, the type of which is determined, from the storage component and set the near-end information;
a near-end detection component configured to detect the near-end of the roll paper set in the paper set component; and
a near-end processing component configured to, only if the near-end information indicating that the near-end is notified is set by the setting component, according to detection of near-end of the roll paper by the near-end detection component, notify the near-end.

15. The thermal printer according to claim 14, wherein
the plurality of types of roll paper comprise receipt roll paper obtained by winding long receipt paper, label roll paper obtained by aligning and winding a plurality of labels in a long direction on a long liner, and liner-less roll paper obtained by winding long liner-less paper,
the storage component stores, in association with the receipt roll paper, near-end information for notifying near-end and stores, in association with the label roll paper and the liner-less roll paper, near-end information for not notifying near-end, and
the setting component sets near-end information indicating that the near-end is notified if the receipt roll paper is determined by the determination component.

16. The thermal printer according to claim 14, wherein, if near-end information indicating that the near-end is not notified is set by the setting component, the near-end processing component does not determine whether near-end of the roll paper is detected by the near-end detection component and does not notify the near-end.

17. The thermal printer according to claim 14, wherein, if near-end information indicating that the near-end is not notified is set by the setting component, even if near-end of the roll paper is detected by the near-end detection component, the near-end processing unit does not notify the near-end.

18. The thermal printer according to claim 14, further comprising a designation key that is operated in order to designate a type of roll paper, wherein
the determination component determines the roll paper for which the designation key operates.

19. The thermal printer according to claim 14, wherein the near-end information comprises near-end disabling information and near-end enabling information.

20. The thermal printer according to claim 14, wherein the determination component determines that when a receipt key is operated, the setting component reads near-end information stored in a near-end setting component corresponding to the roll paper stored in the paper set component and stores the near-end information in the near-end setting component.
